(19) United States
(12) Patent Application Publication
(10) Pub. No.: US 2025/0197133 A1
(43) Pub. Date: Jun. 19, 2025

(54) Labelless marking device

(71) Applicant: Shanghai Onlytec Equipment Co., Ltd., Shanghai (CN)

(72) Inventors: Defu JIANG, Shanghai (CN); Yaofei WANG, Shanghai (CN); Huaiyu LIN, Shanghai (CN)

(73) Assignee: Shanghai Onlytec Equipment Co., Ltd., Shanghai (CN)

(21) Appl. No.: 18/763,919

(22) Filed: Jul. 3, 2024

(30) Foreign Application Priority Data
Dec. 15, 2023 (CN) 2023117270469

(51) Int. Cl. B65G 47/82; B41M 5/24

(52) U.S. Cl. CPC B65G 47/82; B41M 5/24; B65G 2201/0244

(57) ABSTRACT

The present invention discloses a label-free marking device, comprising: a frame, a disc-shaped conveying module, a laser marking module and a first driving module, wherein the disc-shaped conveying module is connected with a feeding device and a discharging device respectively, and packaging bottles enter the disc-shaped conveying module from the feeding device, and return to a conveyor through the discharging device after completing label printing on the disc-shaped conveying module; the laser marking module comprises a plurality of laser heads, the laser heads are arranged on, and distributed around a circumference of, the disc-shaped conveying module, such that the laser heads are movable with the disc-shaped conveying module to mark the packaging bottles at corresponding positions; an output end portion of the first driving module is connected with the disc-shaped conveying module, and can drive the disc-shaped conveying module to rotate. The present invention produces clearer markings, achieves faster marking speed, meets production requirements better, and realizes better marking effects; in the present invention, the marking process is more stable, the adjustment and maintenance are more convenient, and it is easier to change contents and sizes of markings, it is not easy to fail, and the maintenance and production costs are low.

### INCORPORATION BY REFERENCE

This application claims the benefit of priority from China Patent Application No. 2023117270469 filed on Dec. 15, 2023, the contents of which are hereby incorporated by reference in their entirety.

### TECHNICAL FIELD

The present invention relates to the technical field of packaging bottle identification printing equipment, in particular to a label-free marking device.

### BACKGROUND TECHNOLOGY

Currently, adhesive labels (with numbers, text, logos, names, QR codes, barcodes, DM codes, information signs, etc.) are typically placed in middle portions of packaging bottle bodies. After use, the packaging bottle bodies are recycled. However, during the recycling process, it is necessary to remove the adhesive labels on the packaging bottle bodies, which consumes a lot of manpower and resources. Moreover, after removing the adhesive labels, adhesive residues are left on the packaging bottle bodies, resulting in the generation of harmful substances during disposal, leading to low energy-saving and environmental protection value.

In line with the concept of carbon reduction and environmental protection, the idea of “label-less PET bottles” has emerged in the past two years. Several leading companies have begun to lay out in advance in response to energy conservation and carbon reduction. This omits affixing labels with brand logos and product-related information on the bottle body; instead, laser printing technology is applied to mark bottle bodies. By eliminating labels, it is possible to not only reduce the use of plastic in the production process, simplify the recycling of materials, but also decrease the recycling process. However, existing label-less PET bottles can only have a small amount of contents marked on bottle bodies by using laser machines. Complete product information can only be marked on the outer packaging, making it impossible for individual bottle sales and limiting sales channels, thus failing to meet the demand for large-scale, high-capacity production.

The patent application document with a publication number CN116967618A discloses an automatic production device for label-less packaging bottles, comprising a frame, wherein the frame is provided with a bottle conveying device and a bottle marking device, the bottle marking device comprises a rotating shaft mounted on the frame and an active ring disc coaxially fixed to the rotating shaft, on the frame is provided a drive mechanism to rotate the rotating shaft, and at top portions of the active ring disc are rotationally provided placement trays, the placement trays are arranged in a circular array along the circumferential direction of the active ring disc, at bottom portions of the active ring disc are provided self-rotating motors to drive the placement trays to rotate, a follow-up ring disc is coaxially fixed on the rotating shaft, on the follow-up ring disc are provided pressing assemblies corresponding to the placement trays, and, on the frame are provided laser heads for marking bottle bodies. However, the automatic production device for label-less packaging bottles has the following drawbacks: I. the laser heads for marking do not move with the active ring disc but are fixed on the frame, limiting the speed of the active ring disc's rotation and significantly reducing overall marking efficiency; II. during the bottle marking process by the laser heads, the rotation of the active ring disc can cause slight deformation of the markings, resulting in poor marking quality; III. the pressing assemblies use a cylinder-driven method to secure or release the bottle bodies, which is prone to malfunctions over time, and the cost of using cylinder-driven method is high. Therefore, further upgrades and iterations are urgently needed.

### SUMMARY OF THE INVENTION

To solve above technical problems, the present invention provides a label-free marking device, connectable with an external conveying device, wherein the external conveying device comprises a conveyor, a feeding device and a discharging device, and the label-free marking device comprises:
a frame;
a disc-shaped conveying module, wherein the disc-shaped conveying module is connectable with both the feeding device and the discharging device, so as to allow packaging bottles to enter the disc-shaped conveying module from the feeding device, and to return to the conveyor through the discharging device once label printing on the disc-shaped conveying module is completed;
a laser marking module, wherein the laser marking module comprises laser heads, the laser heads are arranged on, and distributed around a circumference of, the disc-shaped conveying module, such that the laser heads are movable with the disc-shaped conveying module to mark the packaging bottles at corresponding positions;
a first driving module, wherein an output end portion of the first driving module is connected with the disc-shaped conveying module, so as to drive the disc-shaped conveying module to rotate;
specifically, the disc-shaped conveying module comprises a first rotating shaft, a first cam disc, a pair of first fixing frames, a first active rotating disc, a first follower disc, first pressing mechanisms and storage trays;
the first rotating shaft is connected to an output end portion of the first driving module;
the first cam disc is sleeved on the first rotating shaft and free from rotation of the first rotating shaft, and an outer ring of the first cam disc is provided with a first cam track;
the pair of first fixing frames are respectively arranged on both sides of the first cam disc and connected to the first cam disc, and are used to fix the first cam disc;
the first follower disc and the first active disc are sequentially sleeved on the first rotating shaft and are configured to rotate with the first rotating shaft; the first active disc is provided with storage trays for placing bottle bodies; and
the first follower disc is provided with first pressing mechanisms respectively corresponding to the storage trays one by one; sides of the first pressing mechanism are provided with first pulleys which are slidably connected to the first cam disc through the first cam track and are arranged to move up and down while moving along circumference of the first cam disc, so as to press or loosen the bottle bodies.

Furthermore, under the storage trays are correspondingly arranged rotating motors, and the rotating motors drive corresponding storage trays to rotate.

Furthermore, the first pressing mechanisms comprise first pressing assemblies and pairs of first guide rods;
the pairs of first guide rods are arranged on the first follower disc;
the first pressing assemblies are sleeved on the pairs of first guide rods and are arranged to slide along the pairs of first guide rods; and
the first pulleys are arranged at sides of the first pressing assemblies and are slidably connected to the first cam disc through the first cam track, and are arranged to move up and down while moving along circumference of the first cam disc.

Furthermore, the first pressing mechanisms further comprise pairs of first springs and pairs of clamping springs;
the pairs of first springs are respectively sleeved on the pairs of first guide rods;
the pairs of clamping springs respectively correspond to the pairs of first springs one by one, are respectively arranged at lower end portions of corresponding pairs of first springs, and are fixedly connected to the pairs of first guide rods; and
the pairs of first springs are arranged between the first pressing assemblies and the pairs of clamping springs.

Furthermore, the first pressing assemblies comprise first sliding frames, first pressing rods and first pressing sleeves;
the first sliding frames are sleeved on the pairs of first guide rods, and the first pulleys are arranged at sides of the first sliding frames;
end portions of the first pressing rods are connected to the first sliding frames, another end portions thereof are movably connected to the first pressing sleeves, and the first pressing sleeves are rotatable around shafts thereof.

Furthermore, the first pressing mechanisms further comprise first fixing plates, and the first fixing plates are disposed at upper end portions of the pairs of first guide rods and are fixedly connected to the pairs of first guide rods.

Furthermore, the laser marking module further comprises a second cam disc, lifting mechanisms, a second follower disc and laser head controllers;
the second cam disc is fixedly connected to the first cam disc via connecting columns, and a second cam track is arranged on an outer ring of the second cam disc;
the second follower disc is fixedly connected to the first follower disc through connecting columns, so as to move synchronously with the first follower disc;
the lifting mechanisms respectively correspond to and are connected to the laser heads one by one, and second pulleys are arranged at sides of the lifting mechanisms, the second pulleys are slidably connected to the second cam disc through the second cam track, and are arranged to move up and down while moving along circumference of the second cam disc; and
the laser head controllers respectively correspond to the laser heads one by one and are arranged on the second follower disc.

Furthermore, the lifting mechanisms comprise second sliding frames and pairs of second guide rods;
the second sliding frames are sleeved on the pairs of second guide rods and are arranged to slide relative to the pairs of second guide rods; the second pulleys are arranged at sides of the second sliding frames and are arranged to drive the second sliding frames to move; and
the pairs of second guide rods are fixedly connected to the first follower disc.

Furthermore, the lifting mechanisms further comprise second fixed plates and pairs of second springs;
the second fixing plates are arranged at upper end portions of the pairs of second guide rods and are fixedly connected to the pairs of second guide rods; and
the pairs of second springs are respectively arranged at two end portions of the second fixing plates, end portions of the second springs are connected to the second fixing plates, and another end portions thereof are connected to the second sliding frames.

Furthermore, between the lifting mechanisms and corresponding laser heads are provided position adjustment mechanisms, and positions between the lifting mechanisms and the laser heads are adjustable through the position adjustment mechanisms.

Furthermore, the first driving module comprises a first driving motor and a transmission gear set; the first driving motor drives the first rotating shaft, the feeding device and the discharging device to move synchronously through the transmission gear set.

Furthermore, the label-free marking device further comprises a first detection camera and a second detection camera; the first detection camera is arranged at one side where the feeding device and the disc-shaped conveying module are connected, and is used to detect whether the bottle bodies enter the disc-shaped conveying module; the second detection camera is arranged at one side where the discharging device and the disc-shaped conveying module are connected, and is used to detect whether there are relevant markings on the bottle bodies.

The present invention has following beneficial effects:
1) The laser heads move synchronously with the disc-shaped conveying module, makes clearer print markings and achieves faster marking speed.
2) The pressing assemblies and the first cam disc cooperate with each other, and a mechanical transmission is adopted, which improves reliability and has low cost.
3) The lifting mechanisms are adopted to make the laser heads follow better and the cost is low.

It should be understood that both the foregoing general description and following detailed description are exemplary and are intended to provide further explanation of technology as claimed.

### BRIEF DESCRIPTION OF THE DRAWINGS

FIG. 1 is a schematic diagram of a stereogram according to an embodiment of the present invention.

FIG. 2 is a front view of FIG. 1.

FIG. 3 is a schematic diagram of a first partial stereogram according to an embodiment of the present invention.

FIG. 4 is an enlarged view of FIG. 3 in an A direction.

FIG. 5 is a schematic diagram of a lifting mechanism according to an embodiment of the present invention.

FIG. 6 is a top view of FIG. 3.

FIG. 7 is a schematic diagram of a second partial stereogram according to an embodiment of the present invention.

FIG. 8 is an enlarged view of FIG. 7 in a B direction.

FIG. 9 is a schematic diagram of a first pressing mechanism according to an embodiment of the present invention.

FIG. 10 is a left view of FIG. 7.

FIG. 11 is an enlarged view of FIG. 10 in a C direction.

FIG. 12 is a schematic diagram of a shape of a first cam track or a second cam track according to an embodiment of the present invention.

FIG. 13 is a schematic diagram of a first cam disc and a pair of first fixing frames fixedly connected according to an embodiment of the present invention.

### SPECIFIC EMBODIMENTS

The following is a detailed description of preferred embodiments of the present invention in conjunction with attached drawings to further elaborate the present invention.

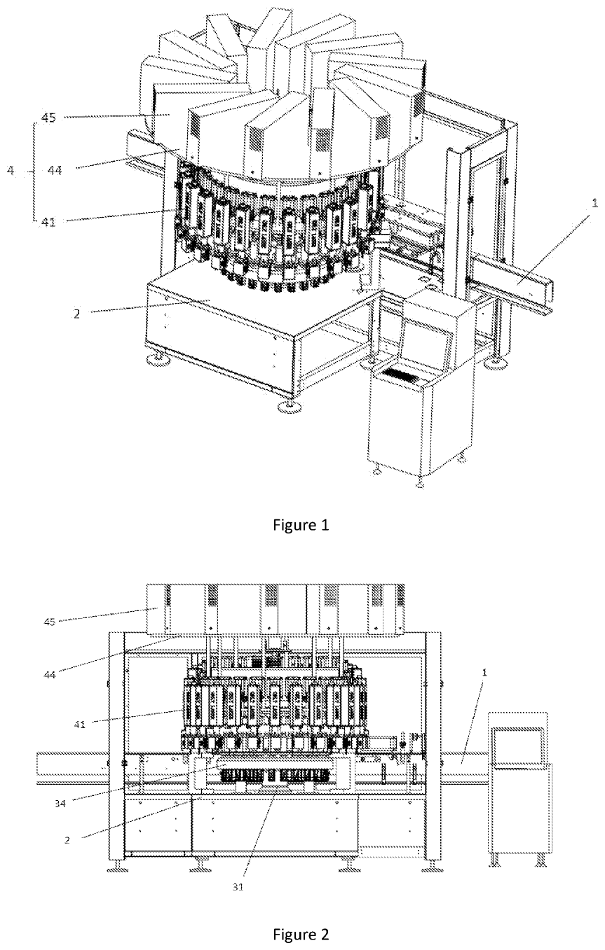

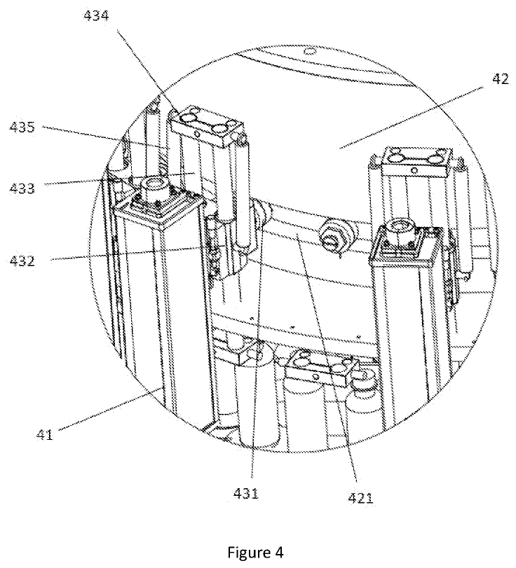

First, a label-free marking device according to embodiments of the present invention will be described in conjunction with FIGS. 1-13, which is used for marking bottles and has a wide range of application scenarios.

As shown in FIGS. 1-13, in an embodiment of the present invention, a label-free marking device is connectable with an external conveying device 1, the external conveying device 1 comprises a conveyor 11, a feeding device 12 and a discharging device 13; and the label-free marking device comprises:
a frame 2;
a disc-shaped conveying module 3, wherein the disc-shaped conveying module 3 is connectable with both the feeding device 12 and the discharging device 13, so as to allow packaging bottles to enter the disc-shaped conveying module 13 from the feeding device 12, and to return to the conveyor 11 through the discharging device 13 once label printing on the disc-shaped conveying module 3 is completed;
a laser marking module 4, wherein the laser marking module 4 comprises laser heads 41, the laser heads 41 are arranged on, and distributed around a circumference of, the disc-shaped conveying module 3, such that the laser heads 41 are movable with the disc-shaped conveying module 3 to mark the packaging bottles at corresponding positions with a good marking effect and a fast marking speed; and
a first driving module 5, wherein an output end portion of the first driving module 5 is connected with the disc-shaped conveying module 3, so as to drive the disc-shaped conveying module 3 to rotate.

Specifically, as shown in FIGS. 2-3, 6-8 and 10-13, in the present embodiment, the disc-shaped conveying module 3 comprises a first rotating shaft 31, a first cam disc 32, a pair of first fixing frames 33, a first active rotating disc 34, a first follower disc 35, first pressing mechanisms 36 and storage trays 37;
the first rotating shaft 31 is connected to an output end portion of the first driving module 5;
the first cam disc 32 is sleeved on the first rotating shaft 31 and free from rotation of the first rotating shaft 31, and an outer ring of the first cam disc 32 is provided with a first cam track 321;
the pair of first fixing frames 33 are respectively arranged on both sides of the first cam disc 32 and connected to the first cam disc 32, and are used to fix the first cam disc 32;
the first follower disc 35 and the first active disc 34 are sequentially sleeved on the first rotating shaft 31 and are configured to rotate with the first rotating shaft 31; the first active disc 34 is provided with storage trays 37 for placing bottle bodies; and
the first follower disc 35 is provided with first pressing mechanisms 36 each corresponding to a respective storage tray 37; sides of the first pressing mechanism are provided with first pulleys 361 which are slidably connected to the first cam disc 32 through the first cam track 321 and are arranged to move up and down while moving along circumference of the first cam disc 32, so as to press or loosen the bottle bodies; and the first pressing mechanisms 36 cooperate with the first cam track 321 to achieve good transmission and avoid failure.

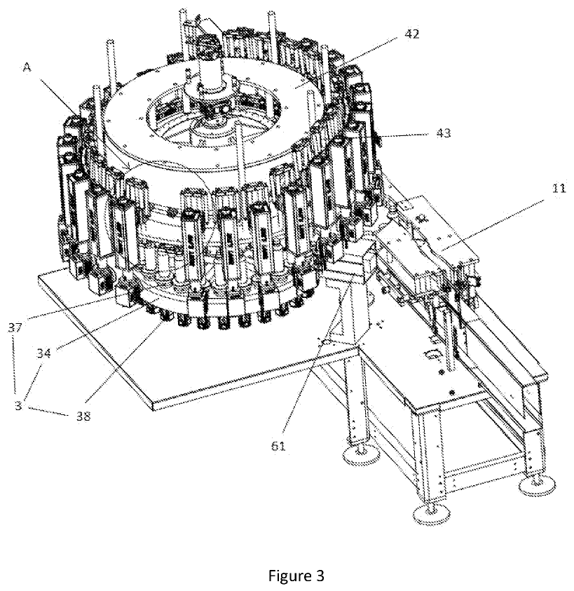

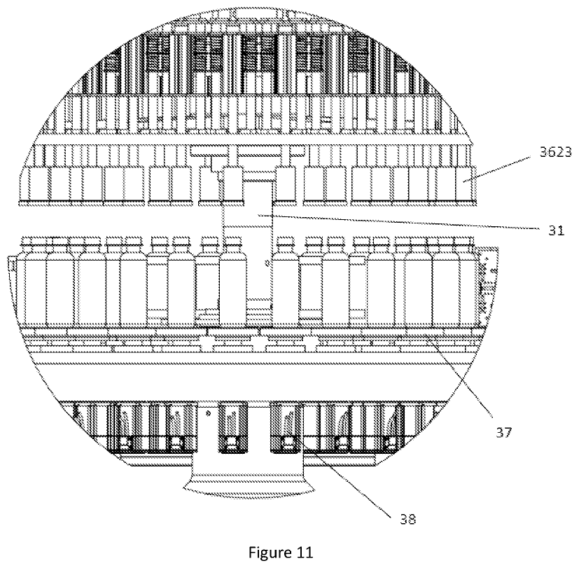

Furthermore, as shown in FIG. 3 and FIG. 11, in the present embodiment, under the storage trays 37 are correspondingly arranged rotating motors 38, the rotating motors 38 drive corresponding storage trays 37 to rotate, and during a marking process of the laser heads 41, the bottle bodies can be rotated according to marking requirements.

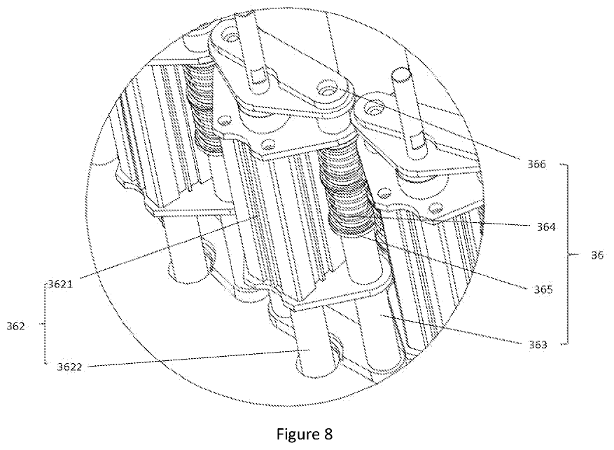

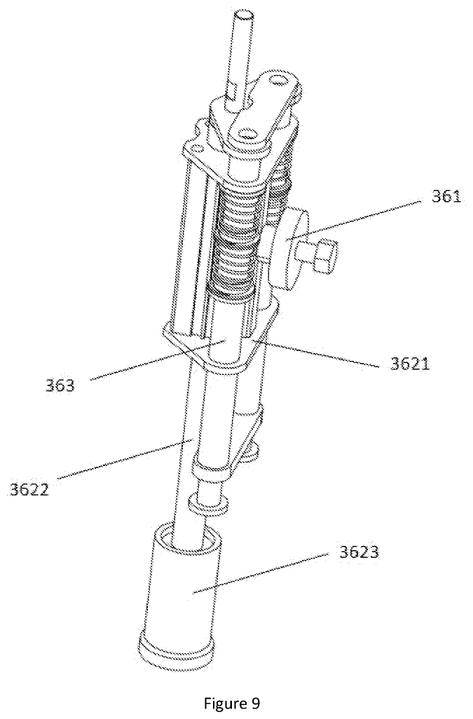

Further, as shown in FIGS. 8-9, in the present embodiment, the first pressing mechanisms 36 comprise first pressing assemblies 362 and pairs of first guide rods 363;
the pairs of first guide rods 363 are arranged on the first follower disc 35;
the first pressing assemblies 362 are sleeved on the pairs of first guide rods 363 and are arranged to slide along the pairs of first guide rods 363; and
the first pulleys 361 are arranged at sides of the first pressing assemblies 362 and are slidably connected to the first cam disc 321 through the first cam track 32, and are arranged to move up and down while moving along circumference of the first cam disc 32.

Furthermore, as shown in FIGS. 8-9, in the present embodiment, the first pressing mechanisms further comprise pairs of first springs 364 and pairs of clamping springs 365;
the pairs of first springs 364 are respectively sleeved on the pairs of first guide rods 363;
the pairs of clamping springs 365 respectively correspond to the pairs of first springs 364 one by one, are respectively arranged at lower end portions of corresponding pairs of first springs 364, and are fixedly connected to the pairs of first guide rods 363; and
the pairs of first springs 364 are arranged between the first pressing assemblies 362 and the pairs of clamping springs 365, and the pairs of first springs 364 are used to buffer the first pressing assemblies 362 and assist the first pressing assemblies 362 to reset.

Furthermore, as shown in FIGS. 8-9, in the present embodiment, the first pressing assemblies 362 comprise first sliding frames 3621, first pressing rods 3622 and first pressing sleeves 3623;
the first sliding frames 3621 are sleeved on the pairs of first guide rods 363, and the first pulleys 361 are arranged at sides of the first sliding frames 3621;
end portions of the first pressing rods 3622 are connected to the first sliding frames 3621, another end portions thereof are movably connected to the first pressing sleeves 3623, and the first pressing sleeves 3623 are rotatable around shafts thereof, so that when the rotating motors 38 drive the storage trays 37 to rotate, the bottle bodies can follow the rotation better.

Furthermore, as shown in FIGS. 8-9, in the present embodiment, the first pressing mechanisms 36 further comprise first fixing plates 366, and the first fixing plates 366 are disposed at upper end portions of the pairs of first guide rods 363 and are fixedly connected to the pairs of first guide rods 363, which on the one hand makes structures of the pairs of first guide rods 363 more stable, and on the other hand is used to limit positions of the first sliding frames 3621.

Furthermore, as shown in FIGS. 1-5, in the present embodiment, the laser marking module 4 further comprises a second cam disc 42, lifting mechanisms 43, a second follower disc 44 and laser head controllers 45;
the second cam disc 42 is fixedly connected to the first cam disc 32 via connecting columns, and a second cam track 421 is arranged on an outer ring of the second cam disc 42;
the second follower disc 44 is fixedly connected to the first follower disc 35 through connecting columns, so as to move synchronously with the first follower disc 35;
the lifting mechanisms 43 respectively correspond to and are connected to the laser heads 41 one by one, and second pulleys 431 are arranged at sides of the lifting mechanisms 43, the second pulleys 431 are slidably connected to the second cam disc 42 through the second cam track 421, and are arranged to move up and down while moving along circumference of the second cam disc 42;
the laser head controllers 45 respectively correspond to the laser heads 41 one by one and are arranged on the second follower disc 44;

Furthermore, as shown in FIGS. 1-5, in the present embodiment, the lifting mechanisms 43 comprise second sliding frames 432 and pairs of second guide rods 433;
the second sliding frames 432 are sleeved on the pairs of second guide rods 433 and are arranged to slide relative to the pairs of second guide rods 433; the second pulleys 431 are arranged at sides of the second sliding frames 432 and are arranged to drive the second sliding frames 432 to move; and
the pairs of second guide rods 433 are fixedly connected to the first follower disc 35.

Furthermore, the lifting mechanisms 43 further comprise second fixed plates 434 and pairs of second springs 435;
the second fixing plates 434 are arranged at upper end portions of the pairs of second guide rods 433 and are fixedly connected to the pairs of second guide rods 433, which on the one hand makes structures of the pairs of second guide rods 433 more stable, and on the other hand is used to limit positions of the second sliding frames 432; and
the pairs of second springs 435 are respectively arranged at two end portions of the second fixing plates 434, end portions of the second springs 435 are connected to the second fixing plates 434, and another end portions thereof are connected to the second sliding frames 432; the pairs of second springs 435 are arranged, which on the one hand buffers the second sliding frames 432 and assists in resetting the second sliding frames 432, on the other hand, offers the second sliding frames 432 upward pulling forces, so that the pressure between the second pulleys 431 and an upper wall of the second cram track 421 is almost zero, thereby greatly reducing the friction between the second pulleys 431 and the upper wall of the second cam track 421 during movement.

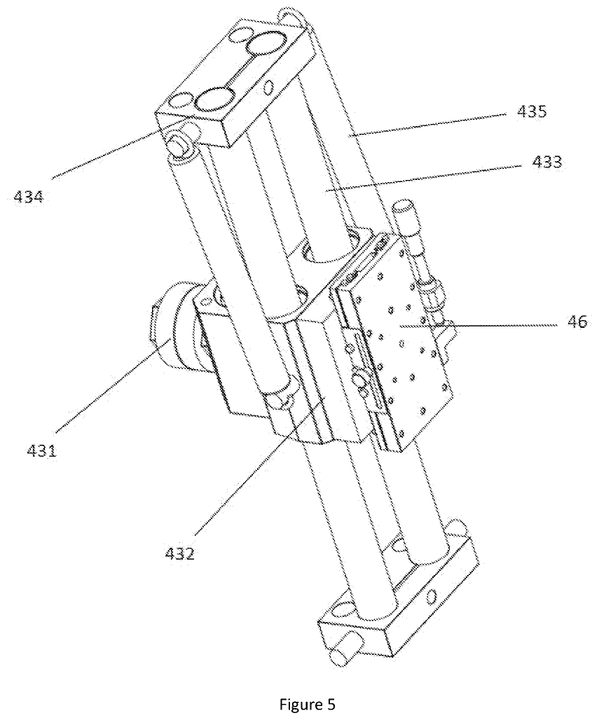

Furthermore, as shown in FIG. 5, in the present embodiment, between the lifting mechanisms 43 and corresponding laser heads 41 are provided position adjustment mechanisms 46, and positions between the lifting mechanisms 43 and the laser heads 41 are adjustable through the position adjustment mechanisms 46, so as to enable the laser heads 41 are in best marking positions.

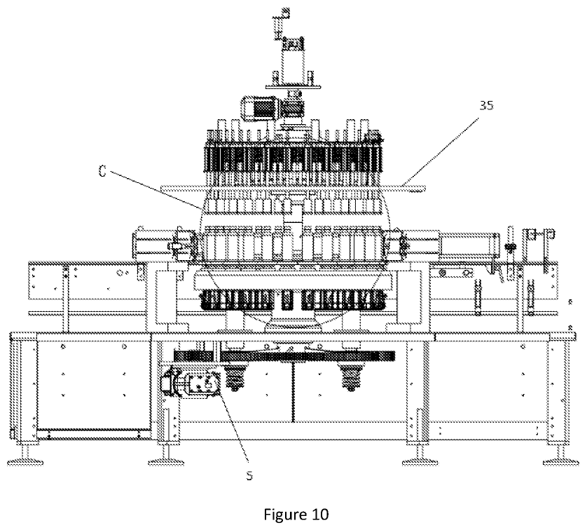

Furthermore, as shown in FIG. 10, in the present embodiment, the first driving module 5 comprises a first driving motor and a transmission gear set; the first driving motor drives the first rotating shaft 31, the feeding device 12 and the discharging device 13 to move synchronously through the transmission gear set.

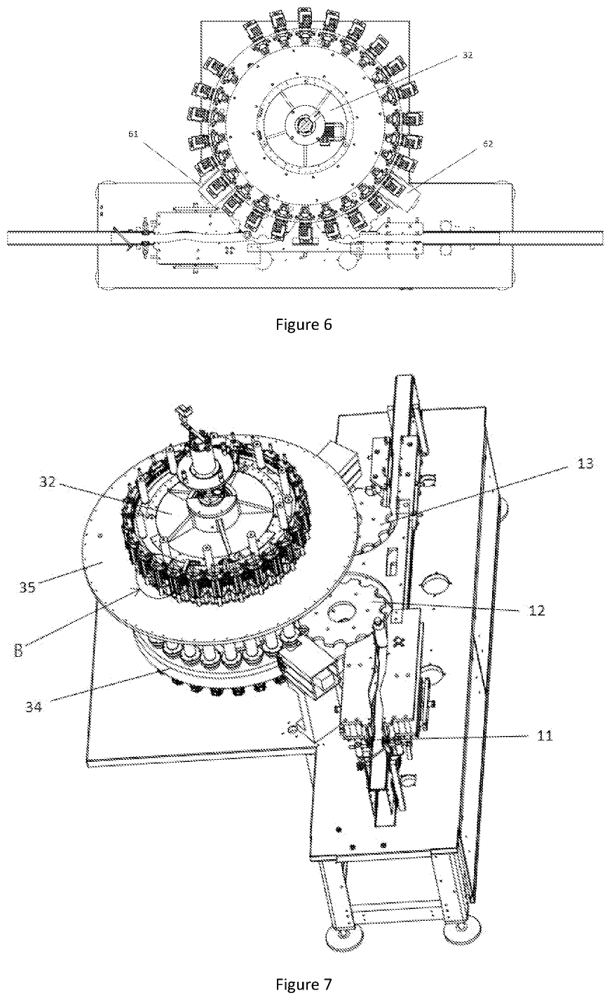

Furthermore, as shown in FIGS. 3 and 6, in the present embodiment, the label-free marking device further comprises a first detection camera 61 and a second detection camera 62; the first detection camera 61 is arranged at one side where the feeding device 12 and the disc-shaped conveying module 3 are connected, and is used to detect whether the bottle bodies enter the disc-shaped conveying module 3; the second detection camera 62 is arranged at one side where the discharging device 13 and the disc-shaped conveying module 3 are connected, and is used to detect whether there are relevant markings on the bottle bodies.

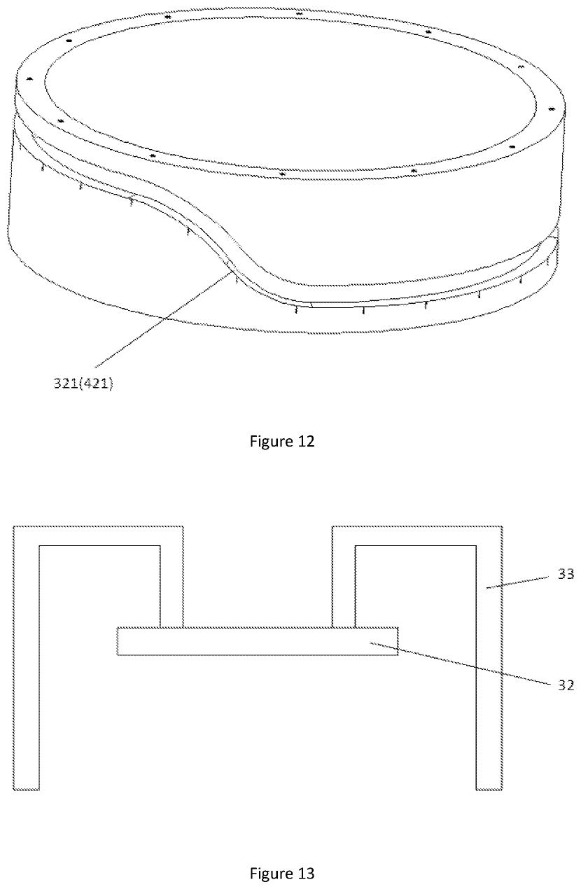

Furthermore, as shown in FIG. 12, in the present embodiment, the first cam track 321 and the second cam track 421 comprise similar shapes and structures.

Working principles of the present invention are as follows: first, bottle bodies enter the storage trays 37 of the disc-shaped conveying module 3 from the feeding device 12, at this point, the first pressing assemblies 362 move with the first pulleys 361 from high positions to low positions of the first cam track 321, so as to press the bottle bodies with the first pressing sleeves 3623, then, the laser heads 41 corresponding to the bottle bodies move with the second pulleys 431 from high positions to low positions of the second cam track 421 and begin marking the bottle bodies; after the bottle bodies are marked during motion thereof, the first pressing assemblies 362 move with the first pulleys 361 from low positions to high positions of the first cam track 321, while the laser heads 41 at corresponding positions on the bottle bodies move with the second pulleys 431 from low positions to high positions of the second cam track 421 and the bottle bodies are discharged from the discharging device 13 and returned to the conveyor 11; and the same goes for all the bottle bodies.

The above describes the label-free marking device according to an embodiment of the present invention with reference to FIGS. 1 to 13, the laser heads move synchronously with the disc-shaped conveying module, to print clearer markings, and achieve faster marking speed; the pressing assemblies and the first cam disc cooperate with each other to adopt mechanical transmission, which improves reliability and has low cost; the lifting mechanisms are adopted to make the laser heads follow better and the cost is lower.

It should be noted that in this specification, the terms “comprises,” “comprising,” or any other variations are intended to encompass a non-exclusive inclusion, such that processes, methods, items, or devices comprising a series of elements include not only those elements explicitly listed but also other elements not explicitly listed or inherent to such processes, methods, items, or devices. In the absence of further limitations, elements specified by the phrase “including . . . ” do not exclude the presence of additional identical elements in processes, methods, items, or devices that include those elements.

Although contents of the present invention have been detailed in the preferred embodiments described above, it should be recognized that the above description should not be considered as limiting the present invention. After reading the foregoing description, those skilled in the art will recognize various modifications and alternatives to the present invention. Therefore, the scope of protection of the present invention should be defined by the appended claims.

1. A label-free marking device, connecting with an external conveying device, wherein the external conveying device comprises a conveyor, a feeding device and a discharging device, and comprising:
a frame;
a disc-shaped conveying module, wherein the disc-shaped conveying module is connected with the feeding device and the discharging device respectively, and packaging bottles enter the disc-shaped conveying module from the feeding device, and return to the conveyor through the discharging device after completing label printing on the disc-shaped conveying module;
a laser marking module, wherein the laser marking module comprises laser heads, the laser heads are distributed along circumference of the disc-shaped conveying module and arranged on the disc-shaped conveying module, so as to move with the disc-shaped conveying module and mark the packaging bottles at corresponding positions;
a first driving module, wherein an output end portion of the first driving module is connected with the disc-shaped conveying module, so as to drive the disc-shaped conveying module to rotate;
the disc-shaped conveying module comprises a first rotating shaft, a first cam disc, a pair of first fixing frames, a first active rotating disc, a first follower disc, first pressing mechanisms and storage trays;
the first rotating shaft is connected to an output end portion of the first driving module;
the first cam disc is sleeved on the first rotating shaft and does not rotate with the first rotating shaft, and an outer ring of the first cam disc is provided with a first cam track;
the pair of first fixing frames are respectively arranged on both sides of the first cam disc and connected to the first cam disc, and are used to fix the first cam disc;
the first follower disc and the first active disc are sequentially sleeved on the first rotating shaft and are able to rotate with the first rotating shaft; the first active disc is provided with storage trays for placing bottle bodies;
the first follower disc is provided with first pressing mechanisms corresponding to the storage trays one by one; sides of the first pressing mechanism are provided with first pulleys which are slidably connected to the first cam disc through the first cam track and are able to move up and down while moving along circumference of the first cam disc, so as to press or loosen the bottle bodies;
the laser marking module further comprises a second cam disc, lifting mechanisms, a second follower disc and laser head controllers;
the second cam disc is fixedly connected to the first cam disc via connecting columns, and on an outer ring of the second cam disc is arranged a second cam track;
the second follower disc is fixedly connected to the first follower disc through connecting columns, so as to move synchronously with the first follower disc;
the lifting mechanisms respectively correspond to and are connected to the laser heads one by one, and second pulleys are arranged at sides of the lifting mechanisms, the second pulleys are slidably connected to the second cam disc through the second cam track, and are able to move up and down while moving along circumference of the second cam disc;
the laser head controllers respectively correspond to the laser heads one by one and are arranged on the second follower disc;
the lifting mechanisms comprise second sliding frames and pairs of second guide rods;
the second sliding frames are sleeved on the pairs of second guide rods and are able to slide relative to the pairs of second guide rods; the second pulleys are arranged at sides of the second sliding frames and are able to drive the second sliding frames to move;
the pairs of second guide rods are fixedly connected to the first follower disc;
the lifting mechanisms further comprise second fixed plates and pairs of second springs;
the second fixing plates are arranged at upper end portions of the pairs of second guide rods and are fixedly connected to the pairs of second guide rods; and
the pairs of second springs are respectively arranged at two end portions of the second fixing plates, end portions of the second springs are connected to the second fixing plates, and another end portions thereof are connected to the second sliding frames.

2. The label-free marking device according to claim 1, wherein the first pressing mechanisms comprise first pressing assemblies and pairs of first guide rods;
the pairs of first guide rods are arranged on the first follower disc;
the first pressing assemblies are sleeved on the pairs of first guide rods and are able to slide along the pairs of first guide rods; and
the first pulleys are arranged at sides of the first pressing assemblies and are slidably connected to the first cam disc through the first cam track, and are able to move up and down while moving along circumference of the first cam disc.

3. The label-free marking device according to claim 2, wherein the first pressing mechanisms further comprise pairs of first springs and pairs of clamping springs;
the pairs of first springs are respectively sleeved on the pairs of first guide rods;
the pairs of clamping springs respectively correspond to the pairs of first springs one by one, are respectively arranged at lower end portions of corresponding pairs of first springs, and are fixedly connected to the pairs of first guide rods; and
the pairs of first springs are arranged between the first pressing assemblies and the pairs of clamping springs.

4. The label-free marking device according to claim 2, wherein the first pressing assemblies comprise first sliding frames, first pressing rods and first pressing sleeves;
the first sliding frames are sleeved on the pairs of first guide rods, and the first pulleys are arranged at sides of the first sliding frames;
end portions of the first pressing rods are connected to the first sliding frames, another end portions thereof are movably connected to the first pressing sleeves, and the first pressing sleeves are rotatable around shafts thereof.

5. The label-free marking device according to claim 2, wherein the first pressing mechanisms further comprise first fixing plates, and the first fixing plates are disposed at upper end portions of the pairs of first guide rods and are fixedly connected to the pairs of first guide rods.

6. The label-free marking device according to claim 1, wherein between the lifting mechanisms and corresponding laser heads are provided position adjustment mechanisms, and positions between the lifting mechanisms and the laser heads are adjustable through the position adjustment mechanisms.

7. The label-free marking device according to claim 3, wherein the first pressing assemblies comprise first sliding frames, first pressing rods and first pressing sleeves;
the first sliding frames are sleeved on the pairs of first guide rods, and the first pulleys are arranged at sides of the first sliding frames;
end portions of the first pressing rods are connected to the first sliding frames, another end portions thereof are movably connected to the first pressing sleeves, and the first pressing sleeves are rotatable around shafts thereof.

8. The label-free marking device according to claim 3, wherein the first pressing mechanisms further comprise first fixing plates, and the first fixing plates are disposed at upper end portions of the pairs of first guide rods and are fixedly connected to the pairs of first guide rods.
